(19) United States
(12) Patent Application Publication
(10) Pub. No.: US 2006/0281424 A1
(43) Pub. Date: Dec. 14, 2006

(54) Ingress susceptibility on return path

(76) Inventor: Kevin J. Oliver, Fishers, IN (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/151,956

(22) Filed: Jun. 14, 2005

(51) Int. Cl. H04B 1/18

(52) U.S. Cl. 455/161.2

(57) ABSTRACT

An apparatus includes an RF input configured to receive RF signals from a communication network subscriber site. The apparatus includes a signal processor operably coupled to the RF input. The signal processor is operable to scan the RF signals for power levels at a plurality of frequencies and generate power level signals based at least in part on the power levels. The apparatus includes a controller operably coupled to the signal processor. The controller is operable, in response to at least one user input command, to cause the signal processor to scan the RF signals for the power levels with the plurality of frequencies spread over at least one predetermined frequency band. At least one of the controller and the signal processor is operable to indicate an ingress susceptibility of the subscriber site in at least one human-perceptible form based at least in part on the power level signals.

### CROSS REFERENCE TO RELATED APPLICATIONS

Cross-reference is made to co-pending U.S. patent application Ser. No. 10/978,698, entitled “Versatile Communication Network Test Apparatus and Methods,” filed Nov. 1, 2004; to co-pending U.S. patent application Ser. No. 10/978,699, entitled “Communication Network Analysis Apparatus With Internetwork Connectivity,” filed Nov. 1, 2004; and to co-pending U.S. patent application Ser. No. 10/978,704, entitled “Signal Level Measurement And Data Connection Quality Analysis Apparatus And Methods,” filed Nov. 1, 2004.

### FIELD OF THE INVENTION

The present invention relates generally to broadband communication systems, and, more particularly, to determining an ingress susceptibility of a communication network from radio frequency (“RF”) signals present on the network.

### BACKGROUND OF THE INVENTION

“Cable networks” are communication systems that typically employ coaxial cables to carry broadband signals between a centralized “head end” and a plurality of customer premises devices. In addition to coaxial cables, many conventional cable networks also include fiber optic lines. Such networks are sometimes called hybrid fiber coax (“HFC”) networks.

Cable networks have historically been used primarily for the delivery of the television program signals. To this end, a cable network head end typically broadcasts a broadband multi-channel television signal to a plurality of subscribers through a hierarchical interconnection of coaxial cable (and/or fiber optic lines) which is often referred to as the “cable plant.” The multi-channel television signal is typically composed of a plurality of different program signals conveyed over separate frequency channels, each channel occupying an approximately 6 MHz wide subband of the overall broadband signal.

While cable service providers have been broadcasting analog NTCS standard television signals for years, they are increasingly converting to digital television signal broadcasting to take advantage of better cost/service ratios. Another increasing trend in cable networks is the addition of two-way high-speed digital data communication. A customer may thus use its cable network connection to obtain both television broadcast programming and to access the Internet for electronic mail, downloads, and browsing. Additionally, an increasing number of HFC networks are also being configured to support a specialized form of digital telephone service known as Voice over Internet Protocol (“VoIP”). Thus, in addition to reliable “downstream” data transmissions from cable network head ends to respective subscriber sites, many of the newer and emerging digital services also require increasingly reliable “upstream” data transmissions from subscriber sites to their respective cable network head ends.

However, electromagnetic noise from common external devices (“ingress”) such as hair dryers, washing machines, and vacuum cleaners, among other things, can dramatically reduce the reliability of upstream data transmissions in a cable network. The hierarchical nature of the typical cable plant tends to increasingly concentrate and amplify ingress in the “return path” (the frequency band used for upstream communications, typically occupying about 5 MHz to 45 MHz under United States standards or about 5 MHz to 65 MHz under European standards) as data flows from the subscriber sites to the head end. Without proper precautions, the resulting signal-to-noise ratio (“SNR”) at the head end can drop low enough to significantly impair the head end's ability to decode messages from subscriber sites.

Determining specifically what should done to harden a cable network against ingress typically involves field testing to locate points of vulnerability and quantify relative degrees of susceptibility in the return path. Once a susceptibility is located, steps can be taken to sufficiently harden the affected network branch and/or node against ingress. In some cases, the remedy may be as simple as replacing a chaffed cable or tightening a loose connector to provide sufficient electromagnetic shielding through the affected branch and/or node.

Cable service providers have often used handheld signal measurement equipment to help diagnose various communications problems and perform network analyses. However, historical ingress test apparatuses and methods have required dedicated radio frequency (“RF”) test signal generating features. Generating dedicated RF test signals has been undesirably costly and complex. Moreover, generating dedicated RF signals can pose undesirable challenges in that return path frequencies typically overlap with commercial aviation bands and, thus, the dedicated RF test signals must be generated and used in ways that avoid high power broadcasting and/or leakage that may interfere with aviation communications. Additionally, apparatuses and methods including dedicated test signals have been undesirably complex and time consuming for technicians to setup and operate in the field.

### SUMMARY OF THE INVENTION

The present invention provides an apparatus including an RF input configured to receive RF signals from a subscriber site of a communication network. The apparatus further includes a signal processor operably coupled to the RF input. The signal processor is operable to scan the RF signals for power levels at a plurality of frequencies and generate power level signals based at least in part on the power levels. The apparatus further includes a controller operably coupled to the signal processor. The controller is operable, in response to at least one user input command, to cause the signal processor to scan the RF signals for the power levels with the plurality of frequencies spread over at least one predetermined frequency band. At least one of the controller and the signal processor is operable to indicate an ingress susceptibility of the subscriber site in at least one human-perceptible form based at least in part on the power level signals.

In an alternative embodiment, the present invention provides a method including scanning radio frequency (“RF”) signals from a subscriber site of a communication network for power levels at a plurality of frequencies spread over at least one predetermined frequency band, and indicating an ingress susceptibility of the subscriber site in at least one human-perceptible form based at least in part on the power levels.

In another alternative embodiment, the present invention provides an apparatus including a means for receiving radio frequency (“RF”) signals from a subscriber site of a communication network, a means for scanning the RF signals for power levels at a plurality of frequencies and generating power level signals based at least in part on the power levels, and a means for receiving at least one user input command and causing the scanning means to scan the RF signals for the power levels with the plurality of frequencies spread over at least one predetermined frequency band in response to the at least one user input command. At least one of the means is operable to indicate an ingress susceptibility of the subscriber site in at least one human-perceptible form based at least in part on the power level signals.

The above-noted features and advantages, as well as others, will become more readily apparent to those of ordinary skill in the art by reference to the following detailed description and accompanying drawings, which include a disclosure of the best mode of making and using the invention presently contemplated. Some variations of the invention may solve other problems not mentioned, and some variations may only solve problems related to those noted above.

### BRIEF DESCRIPTION OF THE DRAWINGS

FIG. 1 shows an exemplary multifunctional cable services system;

FIG. 2 shows an exemplary ingress susceptibility test configuration including an exemplary analysis device according to the present invention coupled to a subscriber site through a drop line at a tap;

FIG. 3 shows a block diagram of the exemplary analysis device of FIG. 2; and

FIG. 4 shows a flow diagram of exemplary ingress susceptibility test operations of the exemplary analysis device of FIG. 2 according to the present invention.

### DETAILED DESCRIPTION

Like reference numerals refer to like parts throughout the following description and the accompanying drawings.

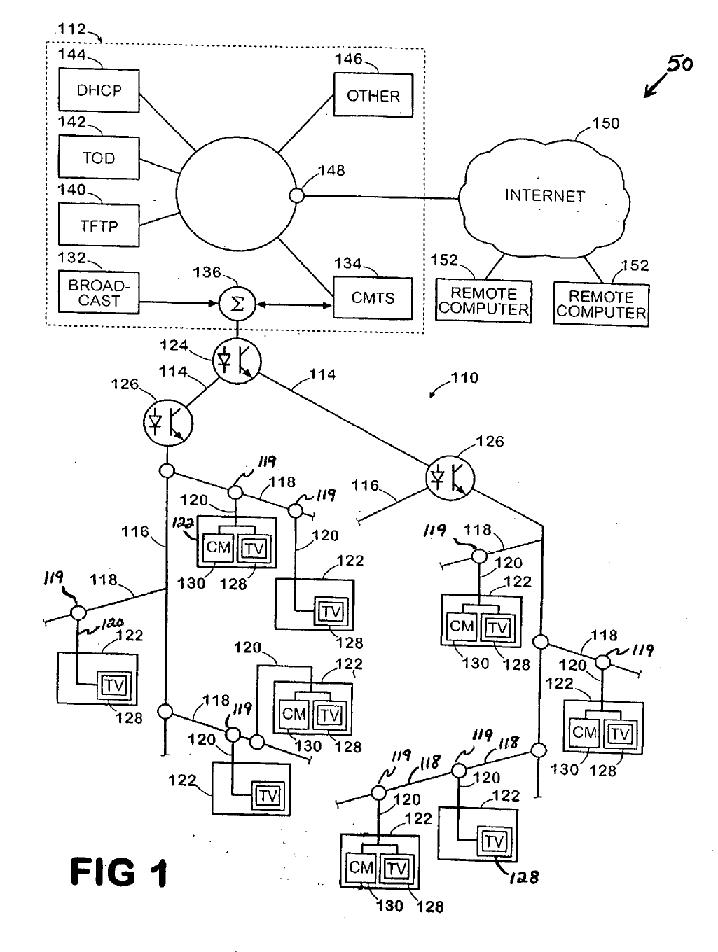

FIG. 1 shows an exemplary multifunctional cable services system 50. Communication network 110 is a land-based broadband network typically known as a cable network. In the exemplary embodiment, communication network 110 is a hybrid fiber coax (“HFC”) network that employs both fiber optic links and coaxial cable to effect radio frequency (“RF”) communications between a plurality of subscribers and a network headend 112. Network headend 112 is further operable to provide Internet communications between a plurality of subscribers and one or more devices 152 connected to the Internet 150. Devices 152 are external to communication network 110.

Communication network 110 includes headend 112, a fiber plant 114, a coaxial cable plant 116, a plurality of network tap lines 118, a plurality of subscriber drop points or taps 119, a plurality of subscriber drop lines 120, and a plurality of subscriber sites 122. In the exemplary embodiment, a headend optical encoder/decoder 124 connects network headend 112 to fiber plant 114, and node optical encoder/decoders 126 connect fiber plant 114 to coaxial cable plant 116. As known in the art, fiber plant 114 provides communication between discrete portions of network 110 and headend 112. Coaxial cable plant 116 distributes network communication line within each discrete portion of network 110.

Both fiber plant 114 and coaxial cable plant 116 are operable to propagate broadband signals, including but not necessarily limited to signals ranging from about 4 MHz to about 1000 MHz. The frequency spectrum is divided into channels that are approximately 6 or 8 MHz wide and includes carrier frequencies that are used to define the respective channels. In general, a carrier signal at the channel frequency is modulated with an information signal using either analog or digital techniques to provide content for the channel.

Headend 112 includes a source of broadcast program information 132, a cable modem termination system (“CMTS”) 134, a combiner 136, and a server network 138. CMTS 134 is operably coupled to combiner 136 and server network 138. Source of broadcast program information 132 is also coupled to the combiner. Combiner 136 is operably connected to optical encoder/decoder 124.

Source of broadcast program information 132 may be any suitable well known device or set of circuits that obtain broadcast audio and/or visual information for broadcast over network 110. For example, source of broadcast program information 132 generally provides local television channels, subscription television channels, pay and free audio channels, free non-local television channels, television guide information and the like.

CMTS 134 is a device, known in the art, that communicates data to and from cable modems 130 connected to the network 110 via network 110. In one embodiment, CMTS 134 is compatible with at least DOCSIS 1.1 standard, which is known in the art. Obviously, in other embodiments, CMTS 134 may be configured for other communication standards, including other DOCSIS standards. CMTS 134 facilitates communication between cable modems 130 and other computers on the Internet 150 via server network 138. The configuration and operation of CMTS 134 is known in the art.

Server network 138 is by way of example a LAN/Ethernet network that has attached to it various servers that perform operations necessary to facilitate Internet connections between cable modems 130 on network 110 and the Internet 150. These servers include, by way of example, a trivial file transfer protocol (“TFTP”) server 140, a time of day (TOD) server 142, and a dynamic host control protocol (“DHCP”) server 144. Each of the above servers implements DOCSIS Internet connection functionality. For example, TFTP server 140 maintains configuration files for each cable modem 130. The configuration file for each cable modem 130 identifies the parameters/constraints of service for modem 130. Such parameters/constraints are often dictated by a level of service purchased for subscriber site 122 associated with modem 130. Thus, the parameters may for example define the maximum available bandwidth, the number of customer premise devices that may be attached to modem 130, etc. Time of day (“TOD”) server 142 provides time stamp information on certain communications between modems 130 and the Internet 150. For example, e-mail messages generated by a modem 130 may be time-stamped using time information from TOD server 142. DHCP server 144 provides the Internet Protocol (“IP”) address assignment for cable modems 130. In general, as is known in the art, each cable modem 130 requests an IP address when it attempts to establish a connection to the Internet 150. DHCP server 144 performs the operations to obtain such addresses.

Additional servers 146 on server network 138 include servers required to provide Voice over Internet Protocol (“VoIP”) services via network 110. VoIP services provide telephony via an Internet connection through cable modems 130 of subscribers. As will be discussed below in further detail, subscribers using such services must include additional equipment connected to cable modem 130. In particular, a device known as a multimedia terminal adapter (“MTA”) must be connected between cable modem 130 and the subscriber telephone. Alternatively, the MTA could be integrated with a cable modem, which is known as an embedded MTA (“eMTA”). Details regarding VoIP services may be found in McIntosh, David, “Building a PacketCable™ Network: A Comprehensive Design for the Delivery of VoIP Services,” (SCTE Cable Tec-Expo® 2002, which may be found at www.cablelabs.com), which is incorporated herein by reference.

Server network 138 further includes a router or switch 148 that connects to the Internet 150. Routers that connect a LAN such as server network 138 to an Internet access point are well known.

Referring to network 110 outside of headend 112, headend optical encoder/decoder 124 is coupled to a plurality of optical lines of optical plant 114. While FIG. 1 shows two optical lines emanating from the headend optical encoder/decoder 124, network 110 may suitably include large number of optical lines in optical plant 114. The lines of optical plant 114 extend to various geographical areas and terminate in node optical encoder/decoders 126. Each optical encoder decoder 126 is further connected to downstream coaxial cables of cable plant 116. Extending from drop points on cable plant 116 are network tap lines 118. Network tap lines 118 are also constructed of coaxial cable. Extending from each network tap line 118 at the tap 119 is one or more subscriber drop line 120. Subscriber drop line 120 provides coaxial cable terminations to subscriber site 122. As is known in the art subscriber site 122 may be a residence, commercial or industrial establishment.

As discussed above, some subscribers have a television 128 operably connected to subscriber drop line 120, a cable modem circuit 130 connected to subscriber drop line 120, or both.

In general, communication network 110 delivers broadband RF signals (including a number of frequency channels, each channel having a unique carrier frequency) to each subscriber drop line 120 that. The carrier signal of each frequency is modulated by information, typically an audio-visual baseband signal, provided from broadcast information source 132. The audio-visual baseband signal may be a standard analog NTSC signal, or a digital television signal.

To this end, the baseband audio-visual baseband information for each broadcast channel is modulated onto a particular channel frequency carrier and then combined with all of the other channel frequency carriers to form a multi-channel broadband RF signal. The broadband RF signal provided to headend optical encoder/decoder 124. Headend optical encoder/decoder 124 converts the broadband RF signal to an optical signal, which then propagates through fiber plant 114 to nodes 126. Nodes 126 convert the optical signal back to a broadband RF signal and then provide the broadband RF signal to the lines of cable plant 116. Cable plant 116, network tap lines 118, taps 119, and subscriber drop lines 120 cooperate to provide the broadband RF signal to each subscriber site 122. If subscriber site 122 has a television 128 operably connected to drop line 120, then television 128 may tune and display any of a plurality of audio-visual programs within the broadband RF signal.

A portion of the broadband signal is reserved for downstream and upstream data packet communication. In the exemplary embodiment, data packet communication is implemented under transfer control protocol/internet protocol (“TCP/IP”) standards, and may be communicated to remote computers 152 over the Internet 150. CMTS 134 effectively transmits downstream data packets to cable modems 130 using known modulation techniques, and receives upstream data packets from cable modems 130 using known demodulation techniques.

CMTS 134 prepares upstream packets for transmission over the Internet 150 in accordance with known standards and techniques. CMTS 134 provides the prepared upstream packets to router 148, which in turn provides the packets to the Internet 150. The Internet 150 may then provide the data packets to one or more remote computers 152. Such data packets may include electronic mail, http requests, web page information, and any other information normally associated with Internet usage.

Packets of data generated by remote computers 152 may be transmitted to a cable modem 130 of the network using a reverse path. VoIP services also use the same path.

As discussed above, TFTP server 140, TOD server 142 and DHCP server 144 also perform operations in Internet communications via CMTS 134. As is known in the art, TFTP server 140 includes a configuration on file that defines constraints on the communication parameters for each modem 130, such as bandwidth limitations or the like. As is also known in the art, TOD server 142 provides time-stamp information to cable modems 130 for event logging. DHCP server 144 establishes a dynamic IP address for each modem 130 (and associated MTA's, not shown in FIG. 1) when modem 130 attempts to connect to the Internet 150 via CMTS 134.

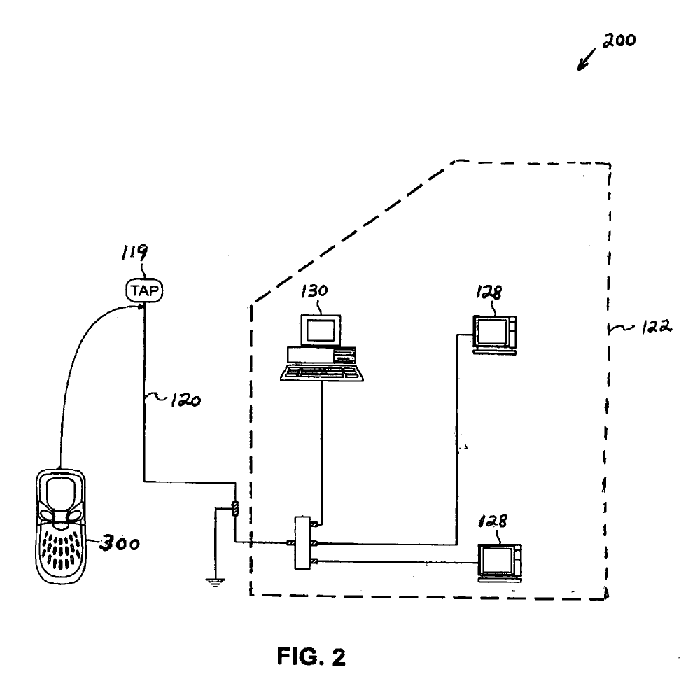

FIG. 2 shows an exemplary ingress susceptibility test configuration 200 including an exemplary analysis device 300 according to the present invention coupled to a subscriber site 122 through a drop line 120 at a tap 119. In the exemplary embodiment, analysis device 300 is operable to indicate an ingress susceptibility as discussed further below. Further, the exemplary analysis device 300 may be operable to test other parameters, including by way of example, the signal strength at a remote location of the network 110, whether Internet connectivity is available at remote locations of the network 110, and/or digital channel quality at remote locations of the network 110. The precise combination of such additional features in the analysis device 300 may vary from embodiment to embodiment. In the exemplary embodiment, analysis device 300 is connected directly to subscriber coax drop line 120 at tap 119. In various alternative embodiments, analysis device 300 may also be intended to test or analyze other aspects of the performance of network 110 in a variety of locations, particularly those proximate one or more subscriber premises site 122. It should be appreciated, however, that a service provider (i.e. a party that provides communication services via network 110) often receives notification of trouble in network 110 through customer complaints. Because the customer can typically only describe visible symptoms of a problem (e.g. cable modem won't connect, slow internet connectivity, fuzzy television picture, etc.), actual diagnosis of the problem often requires testing that is performed at the complaining subscriber's premises.

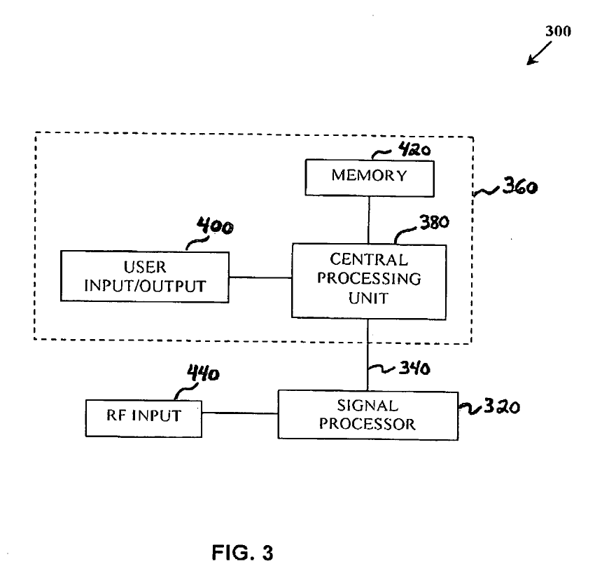

FIG. 3 shows a block diagram of exemplary analysis device 300. Analysis device 300 includes a signal processor 320 connected over an interface bus 340 to a controller 360. Controller 360 includes a central processing unit (“CPU”) 380 connected to a user input/output device(s) 400 and to an additional memory device(s) 420. In the exemplary embodiment, input/output device(s) 400 include typical user interface devices such as a video screen, a keyboard, and/or a printer. More specifically, in the exemplary embodiment signal processor 320 is implemented from a Hewlett Packard model HP8566 programmable spectrum analyzer or suitably similar circuitry and/or equipment, bus 340 is implemented from an IEEE 488 interface bus or suitably similar circuitry and/or equipment, and controller 360 is implemented from a Hewlett Packard model HP9836 computer system or suitably similar circuitry and/or equipment. Among other things, signal processor 320 is configured to make a plurality of power level measurements of RF signals at different frequencies over a frequency interval or band defined by frequency limits supplied by controller 360, and is further configured to transfer corresponding power level signals to controller 360 in response to control signals from controller 360. To this end, basic operations of signal processor 320 are well known to those skilled in the art. Nevertheless, additional details of the construction and operation of the HP8566 programmable spectrum analyzer circuitry incorporated into the exemplary embodiment are provided by the 8566A SPECTRUM ANALYZER REMOTE OPERATION, manual (part No. 08566-90003) available from Hewlett Packard Corporation, which is hereby expressly incorporated by reference. Similarly, additional details of the construction and operation of the HP9836 computer system and the IEEE 488 interface bus are contained in the Tutorial Description of Hewlett Packard Bus Interface available from Hewlett Packard Corporation, which is also hereby expressly incorporated by reference. Exemplary analysis device 300 also includes a radio frequency (“RF”) input 440 configured to be coupled to a communication network subscriber site drop line 120 (see, e.g., FIG. 1 and FIG. 2, discussed above) and to convey RF signals from drop line 120 to signal processor 320 in a known manner.

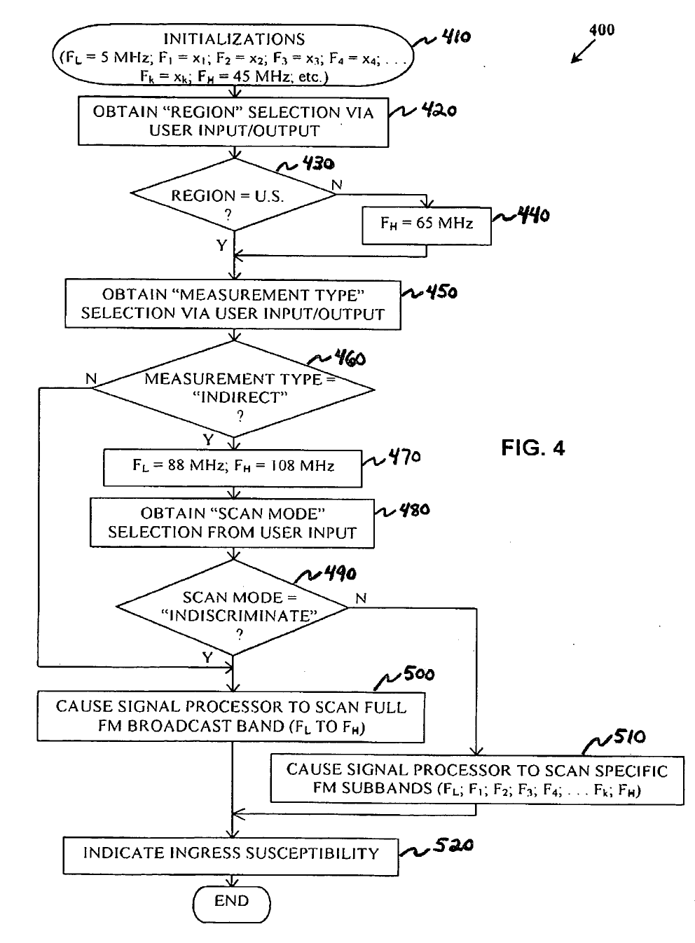

FIG. 4 shows a flow diagram 400 of exemplary ingress susceptibility test operations of analysis device 300 according to the present invention. In general, during operation of analysis device 300 RF input 440 conveys RF signals from subscriber site 122 to signal processor 320 for analysis, signal processor 320 measures power levels of the RF signals at a plurality of frequencies under the control of controller 360 via control signals transmitted from controller 360 to signal processor 320 over bus 340, signal processor 320 in turn transmits corresponding power level signals to controller 360 over bus 340, and controller 360 converts the power level signals into a human-perceptible indication of the ingress susceptibility of subscriber site 122.

More particularly, at block 410 controller 360 initializes its operating variables and sends one or more signals to signal processor 320 that cause signal processor 320 to initialize as well. In the exemplary embodiment, block 410 operations include central processing unit 380 setting a low frequency variable, F_{L}, to 5 MHz, setting a high frequency variable, F_{H}, to 45 MHz, and setting a plurality of intermediate frequency variables, Fₖ, to values roughly evenly spaced between F_{L} and F_{H} in memory 420. After block 410, operations proceed to block 420.

At block 420, controller 360 obtains a “REGION” selection from a user via user input/output 400. As noted above, the return path for a cable network typically occupies about 5 MHz to 45 MHz under United States standards or about 5 MHz to 65 MHz under European standards. The REGION selection indicates whether the user wants analysis device 300 to make any direct measurement (as opposed to an “INDIRECT MEASUREMENT,” discussed further below) of the ingress susceptibility of subscriber site 122 under United States standards (i.e., over a predetermined frequency band of 5 MHz to 45 MHz) or under European standards (i.e., over a predetermined frequency band of 5 MHz to 65 MHz). In the exemplary embodiment, block 420 operations include central processing unit 380 causing user input/output 400 to display one or more prompts for the REGION selection as well as user input/output 400 receiving one or more user input commands indicating the REGION selection and user input/output 400 communicating the REGION selection commands to central processing unit 380. After block 420, operations proceed to block 430.

At block 430, central processing unit 380 decides whether the REGION selection indicates a desire for the United States return path frequency band. If central processing unit 380 determines that the United States band is desired then operations skip to block 450; else, operations proceed to block 440.

At block 440, central processing unit 380 sets the high frequency variable, F_{H}, to 65 MHz. After block 440, operations proceed to block 450.

At block 450, controller 360 obtains a “MEASUREMENT TYPE” selection from the user via user input/output 400. As noted above, the return path for a cable network typically occupies about 5 MHz to 45 MHz under United States standards or about 5 MHz to 65 MHz under European standards. The MEASUREMENT TYPE selection indicates whether the user wants analysis device 300 to make a “DIRECT” measurement of the ingress susceptibility of subscriber site 122 by scanning the actual United States or European return path frequency band (whichever has been selected at block 420, above) or whether the user wants to analysis device 300 to make an “INDIRECT” measurement of the ingress susceptibility of subscriber site 122 by scanning the generally recognized frequency modulated (“FM”) radio signal airwave broadcast communications band of 88 MHz to 108 MHz. Here, it is noted that although independent sources of ingress noise within the actual return path band could be intermittent and/or otherwise considerably unreliable, the option for INDIRECT determination of ingress susceptibility via the FM broadcast band (which is sufficiently close in frequency to the actual United States and European return path bands to make a good proxy for them) ensures at least one operating mode that employs a relatively ubiquitous and reliable independent noise source—without the need for dedicated noise signal equipment, setup, and/or generation. In the exemplary embodiment, block 450 operations include central processing unit 380 causing user input/output 400 to display one or more prompts for the MEASUREMENT TYPE selection as well as user input/output 400 receiving one or more user input commands indicating the MEASUREMENT TYPE selection and user input/output 400 communicating the MEASUREMENT TYPE selection commands to central processing unit 380. After block 450, operations proceed to block 460.

At block 460, central processing unit 380 decides whether the MEASUREMENT TYPE selection indicates a desire for INDIRECT measurement of the ingress susceptibility of subscriber site 122. If central processing unit 380 determines that INDIRECT measurement is desired then operations proceed to block 470; else, operations skip to block 500.

At block 470, central processing unit 380 sets the low frequency variable, F_{L}, to 88 MHz and sets the high frequency variable, F_{H}, to 108 MHz. After block 470, operations proceed to block 480.

At block 480, controller 360 obtains a “SCAN MODE” selection from a user via user input/output 400. The SCAN MODE selection indicates whether the user wants analysis device 300 to perform an “INDISCRIMINATE” measurement of the ingress susceptibility of subscriber site 122 by sweeping the entire FM broadcast band (from F_{L} to F_{H}) with the best resolution available from signal processor 320 or whether the user wants analysis device 300 to perform a more “DISCRIMINATE” measurement of the ingress susceptibility of subscriber site 122 only across one or more specific predetermined FM radio broadcast station frequency subbands. In the exemplary embodiment, block 480 operations include central processing unit 380 causing user input/output 400 to display one or more prompts for the SCAN MODE selection as well as user input/output 400 receiving one or more user input commands indicating the SCAN MODE selection and user input/output 400 communicating the SCAN MODE selection commands to central processing unit 380. After block 480, operations proceed to block 490.

At block 490, central processing unit 380 decides whether the SCAN MODE selection indicates a desire for an “INDISCRIMINATE” measurement of the ingress susceptibility of subscriber site 122 as discussed above. If central processing unit 380 determines that INDISCRIMINATE measurement is desired then operations proceed to block 500; else, operations skip to block 510.

At block 500, controller 360 causes signal processor 320 to measure the power levels of the RF signals from subscriber site 122 across the full FM broadcast band (from F_{L} to F_{H}) at a plurality of frequencies with the best resolution available from signal processor 320, and to generate power level signals representative of the power level measurements. After block 500, operations proceed to block 520.

At block 510, controller 360 causes signal processor 320 to measure the power levels of the RF signals from subscriber site 122 across one or more specific predetermined FM radio broadcast station frequency subbands with the best resolution available from signal processor 320, and to generate power level signals representative of the power level measurements. After block 510, operations proceed to block 520.

At block 520, controller 360 obtains the power level signals from signal processor 320 and central processing unit 380 causes user input/output 400 to indicate the ingress susceptibility of subscriber site 122 based on the power level signals as a spectral display, a continuous or stepwise display or tone corresponding to an average of the power levels, a bipolar (i.e., under-limit/over-limit) display or tone corresponding to an average of the power levels, or in any other suitable human-perceptible form.

It will be appreciated that the above-described embodiment(s) are merely exemplary, and that those of ordinary skill in the art may readily devise their own implementations and adaptations that incorporate the principles of the present invention and fall within the spirit and scope thereof.

What is claimed is:

1. An apparatus, comprising:
a radio frequency (“RF”) input configured to receive RF signals from a subscriber site of a communication network;
a signal processor operably coupled to the RF input, the signal processor operable to scan the RF signals for power levels at a plurality of frequencies and operable to generate power level signals based at least in part on the power levels; and
a controller operably coupled to the signal processor, the controller operable, in response to at least one user input command, to cause the signal processor to scan the RF signals for the power levels with the plurality of frequencies spread over at least one predetermined frequency band;
wherein at least one of the controller and the signal processor is operable to indicate an ingress susceptibility of the subscriber site in at least one human-perceptible form based at least in part on the power level signals.

2. The apparatus of claim 1, wherein the at least one predetermined frequency band includes a first predetermined frequency band extending from about 88 MHz to about 108 MHz.

3. The apparatus of claim 2, wherein the frequencies are limited to a plurality of frequency subbands within the first predetermined frequency band.

4. The apparatus of claim 2, wherein the at least one predetermined frequency band includes a second predetermined frequency band extending from a first frequency to a second frequency, the first frequency being about 5 MHz and the second frequency being one of about 45 MHz and 65 MHz.

5. The apparatus of claim 4, wherein the frequencies are limited to a plurality of frequency subbands within the first predetermined frequency band.

6. The apparatus of claim 5, wherein the controller is further operable to cause communication of at least one of a first prompt for a first user input indicative of a selection between the first frequency and the second frequency, a second prompt for a second user input indicative of a selection between the first predetermined frequency band and the second predetermined frequency band, and a third prompt for a third user input indicative of a desire to limit the frequencies to the plurality of frequency subbands.

7. The apparatus of claim 1, wherein the at least one human-perceptible form includes a visually perceptible form.

8. The apparatus of claim 1, wherein the at least one human-perceptible form includes a bipolar form.

9. The apparatus of claim 8, wherein the bipolar form includes a visually perceptible form.

10. A method, comprising:
scanning radio frequency (“RF”) signals from a subscriber site of a communication network for power levels at a plurality of frequencies spread over at least one predetermined frequency band; and
indicating an ingress susceptibility of the subscriber site in at least one human-perceptible form based at least in part on the power levels.

11. The method of claim 10, wherein the scanning includes scanning the RF signals over a first predetermined frequency band extending from about 88 MHz to about 108 MHz.

12. The method of claim 11, wherein the scanning further includes limiting the frequencies to a plurality of frequency subbands within the first predetermined frequency band.

13. The method of claim 11, wherein the scanning includes scanning the RF signals over a second predetermined frequency band extending from a first frequency to a second frequency, the first frequency being about 5 MHz and the second frequency being one of about 45 MHz and 65 MHz.

14. The method of claim 13, wherein the scanning includes limiting the frequencies to a plurality of frequency subbands within the first predetermined frequency band.

15. The method of claim 14, further comprising:
generating at least one of a first prompt for a selection between the first frequency and the second frequency, a second prompt for a selection between the first predetermined frequency band and the second predetermined frequency band, and a third prompt for a selection to limit the frequencies to the plurality of frequency subbands.

16. The method of claim 10, wherein the indicating includes indicating the ingress susceptibility in a visually perceptible form.

17. The method of claim 10, wherein the indicating includes indicating the ingress susceptibility in a bipolar form.

18. The method of claim 17, wherein the indicating includes indicating the ingress susceptibility a visually perceptible form.

19. An apparatus, comprising:
a means for receiving radio frequency (“RF”) signals from a subscriber site of a communication network;
a means for scanning the RF signals for power levels at a plurality of frequencies and generating power level signals based at least in part on the power levels; and
a means for receiving at least one user input command and causing the scanning means to scan the RF signals for the power levels with the plurality of frequencies spread over at least one predetermined frequency band in response to the at least one user input command;
wherein at least one of the means is operable to indicate an ingress susceptibility of the subscriber site in at least one human-perceptible form based at least in part on the power level signals.

20. The apparatus of claim 19, wherein the at least one predetermined frequency band includes a first predetermined frequency band extending from about 88 MHz to about 108 MHz.
